(19) United States
(12) Patent Application Publication
(10) Pub. No.: US 2010/0150361 A1
(43) Pub. Date: Jun. 17, 2010

(54) APPARATUS AND METHOD OF PROCESSING SOUND

(76) Inventors: Young-tae KIM, Seongnam-si (KR); Jung-ho Kim, Yongin-si (KR); Sang-chul Ko, Seoul (KR); Jung-woo Choi, Hwaseong-si (KR)

Correspondence Address: North Star Intellectual Property Law, PC, P.O. Box 34688, Washington, DC, 20043, US

(21) Appl. No.: 12/554,046

(22) Filed: Sep. 4, 2009

(30) Foreign Application Priority Data
Dec. 12, 2008 (KR) 10-2008-0126406

(51) Int. Cl. H04R 29/00; H04B 15/00

(52) U.S. Cl. 381/59; 381/94.1

(57) ABSTRACT

A technology for controlling acoustic energy distribution in a control region is provided. A sound processing apparatus includes a control filter such that a controllable sound zone is formed in the control region, and the sound processing apparatus synthesizes the control filter and an input signal to transfer sound to a desired location or a specific user. The numbers, the size and the locating positions of the sound zone and/or the control region may be controlled.

### CROSS REFERENCE TO RELATED APPLICATION

This application claims the benefit under 35 U.S.C. §119(a) of Korean Patent Application No. 10-2008-126406, filed on Dec. 12, 2008 in the Korean Intellectual Property Office, the disclosure of which is incorporated herein in its entirety by reference for all purposes.

### BACKGROUND

1. Field

The following description relates to sound equipment, and more particularly, to a technology for transfer of sound to a particular user or a specific position.

2. Description of the Related Art

There is interest in personal sound zone technology which can transfer sound to a specific listener only, without disturbing others by causing noise pollution and without using a headset or earphones.

To focus sound on a particular area, a method of maximizing directivity of sound transferred through the air may be performed with a special speaker (e.g. an ultrasonic transducer) for high power/high frequency oscillation, or with a sound wave guide (e.g. a horn, a reflector, etc.).

However, the above method requires an additional device, and transmission efficiency is relatively low, such that a high-power amplifying device is additionally included. Moreover, the above method has sound distortion that may be too high for the above method to be employed to general electronic devices.

There is another method of assigning a phase difference to a signal to be input to each of a plurality of speakers such that the direction of sound output from the plurality of speakers is focused in a given direction.

However, the second above method focuses the sound on only one point and cannot control the size of a particular area (i.e. sound zone) at an arbitrary position. Therefore, the second above method cannot be applied to many use environments. In other words, according to the conventional art, the performance of a device rapidly deteriorates as a user moves out of the sound zone, and only the targeted point is controlled such that that the size or the location of the sound zone cannot be changed for several users. Particularly, if a small device (e.g. a mobile phone) with a width smaller than a distance between user's ears, to which the above method is applied, is operated close to the user, the above methods cannot implement a desired performance when a relatively larger sound zone is required.

### SUMMARY

In one general aspect, a sound processing apparatus for processing an input signal includes a filter storing unit for storing filter coefficients for controlling the amplitude or a phase of the input signal, and a signal processing unit for processing the input signal according to at least one of the filter coefficients, wherein a sound zone is formed in a control region according to the at least one of the filter coefficients.

The numbers, sizes, and locating positions of the control region and/or the sound zone may be controlled according to the at least one of the filter coefficients.

The filter coefficients may be determined according to a condition where a difference between a first sound characteristic obtained by a primary acoustic transfer function and a second sound characteristic obtained by a second acoustic transfer function is below a predetermined value. The sound characteristic may be acoustic energy distribution.

The primary acoustic transfer function may be an acoustic transfer function measured between a user and a virtual sound source located at an arbitrary position within the control region and the second acoustic transfer function may be an acoustic transfer function measured between the user and an actual sound source.

The sound zone has acoustic energy that may be different than acoustic energy of a remaining area of the control region.

The sound processing may further include a channel splitting unit for splitting the input signal into individual channel signals, wherein the input signal comprises a plurality of channel signals.

The filter storing unit may apply a different filter coefficient to each of the plurality of individual channel signals split by the channel splitting unit.

The sound processing apparatus may further include a sensor unit to detect a user's location.

The control region and the sound zone may be determined according to the user's location.

In another general aspect, a sound processing method of processing an input signal includes storing filter coefficients for controlling an amplitude or a phase of the input signal, and processing the input signal according to at least one of the filter coefficients, wherein a sound zone is formed in a control region according to the at least one of the filter coefficients.

The storing of the filter coefficients may include measuring a first sound characteristic obtained by a primary acoustic transfer function between a user and a virtual sound source located at an arbitrary position within the control region, measuring a second sound characteristic obtained by a second acoustic transfer function between the user and an actual sound source, and generating the filter coefficients for transforming the sound source such that a difference between the first sound characteristic and the second sound characteristic is below a predetermined value. The sound characteristic may be acoustic energy distribution.

The filter coefficient may be determined in an iterative manner.

The filter coefficient may be determined by matrix inversion.

The filter coefficients may include a plurality of sets of filter coefficients, and numbers, sizes, and locating positions of the control region and/or the sound zone are adjusted according to a combination of the plurality of sets of the filter coefficient.

When the input signal includes a plurality of channel signals, the processing of the input signal may include applying a different filter coefficient to each of the plurality of individual channel signals.

Other features and aspects will become apparent to those skilled in the art from the following detailed description, the drawings, and the claims.

### BRIEF DESCRIPTION OF THE DRAWINGS

FIG. 1 is a diagram illustrating an exemplary sound processing apparatus.

FIG. 2 is a graph illustrating an exemplary control region and an exemplary sound zone.

FIG. 3 is a graph illustrating an exemplary control region and another exemplary sound zone.

FIG. 4 is a block diagram illustrating an exemplary configuration of a sound processing apparatus.

FIGS. 5 and 6 are diagrams illustrating exemplary filter coefficients.

FIG. 7 is a diagram illustrating an exemplary method of generating filter coefficients.

FIG. 8 is another diagram illustrating an exemplary method of generating filter coefficients.

FIGS. 9 and 10 are diagrams illustrating an exemplary sound processing apparatus.

FIGS. 11 and 12 are diagrams illustrating an exemplary application of the sound processing apparatus.

FIG. 13 is a diagram illustrating an exemplary sound processing apparatus.

FIG. 14 is a flowchart illustrating an exemplary method of processing sound.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will be suggested to those of ordinary skill in the art. Descriptions of well-known functions and structures may be omitted for increased clarity and conciseness.

FIG. 1 is a diagram illustrating an exemplary sound processing apparatus 100. Referring to FIG. 1, the sound processing apparatus 100 for processing an input signal containing sound information and outputting the processed signal may be employed for personal electronic devices such as televisions, notebook PCs, personal computers, mobile phones, and the like, for relatively noiseless private listening.

Furthermore, the sound processing apparatus 100 may control the input signal such that a sound zone 102 is formed at a particular location within a control region 101. Here, the control region 101 may be an arbitrary region where acoustic energy distribution is to be generated. The acoustic energy distribution generated in the control region 101 may be controlled such that the sound zone may refer to a region where an acoustic energy is set relatively high or low according to the control. Additionally, there may be a plurality of control regions 101, and the number and sizes of sound zones 102 in each control region 101 may be variable.

The control of the input signal may be performed by a predetermined control filter. For example, the sound processing apparatus 100 generates a plurality of filter coefficients, synthesizes the generated coefficients with an input signal to generate a multi-channel signal. The multi-channel signal is applied to a speaker to form the sound zone 102 in the control region 101.

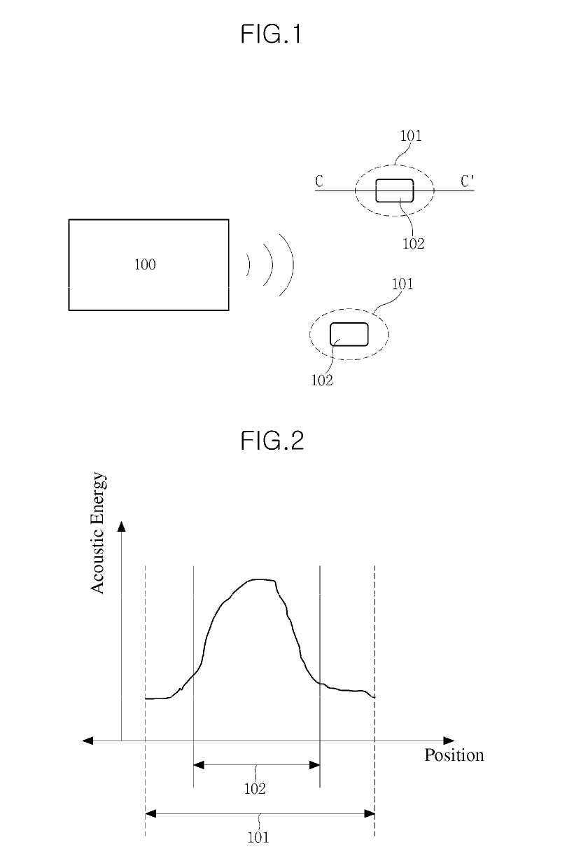

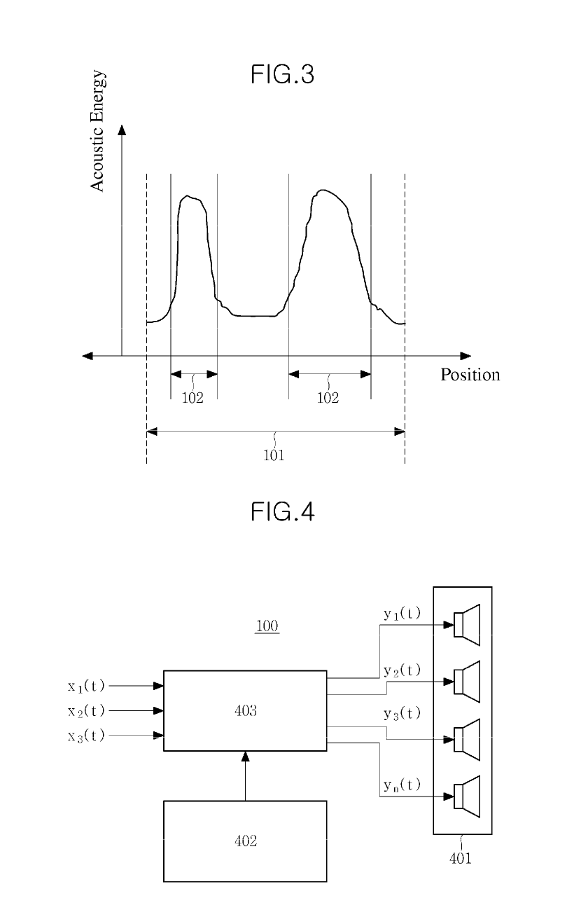

FIGS. 2 and 3 are graphs illustrating an exemplary control region and exemplary sound zones. These graphs illustrate acoustic energy distribution in a cross-section taken along line C-C′ in FIG. 1.

In FIG. 2, where a vertical axis indicates the amplitude of the acoustic energy, numeral reference 101 denotes the control region and numeral reference 102 indicates the sound zone, the sound zone 102 is formed at an area in the control region 101 where the amplitude of the acoustic energy is relatively high. The number of sound zones 102 and the range (i.e. the size) of each sound zone 102 may be adjusted. For example, referring to FIG. 3, two sound zones 102 with different sizes are formed in the control region 101.

An example of the configuration of a sound processing apparatus 100 for forming a controllable sound zone in a predetermined region (e.g. a control region) is described below with reference to FIG. 4.

FIG. 4 is a block diagram illustrating an exemplary configuration of a sound processing apparatus 100. As shown in FIG. 4, the sound processing apparatus 100 includes a speaker unit 401, a filter storing unit 402, and a signal processing unit 403.

The speaker unit 401 for producing sound may be formed as an array speaker including a plurality of speaker modules.

The filter storing unit 402 provides filter coefficients for controlling the amplitude or the phase of an input signal to form the sound zone 102 in the control region 101, as shown in FIGS. 2 and 3. That is, the number of control regions 101 or sound zones 102, and the forming location, and/or size of each of the control regions 101 and the sound zones 102 may be controlled according to the filter coefficients provided by the filter storing unit 402.

The filter coefficients may be applied to an acoustic transfer function, which specifies a characteristic of transmitting sound from a particular location to an arbitrary location (point) and may be obtained using an analytical or experimental method. For example, the filter coefficients may be determined according to a condition where a difference between a first acoustic energy distribution obtained by a primary acoustic transfer function (hereinafter, referred to as a primary ATF) and a second acoustic energy distribution obtained by a second acoustic transfer function (hereinafter, referred to as a second ATF) is at a minimum. In this case, the filter coefficients may be measured where the primary ATF specifies the acoustic transfer characteristic between a user and any virtual sound source located at an arbitrary position in the control region 101, and the second ATF specifies the acoustic transfer characteristic between the user and the actual sound source.

The signal processing unit 403 selects a particular filter coefficient from the filter storing unit 402, and processes the input signal according to the selected filter coefficients. The processed input signal is assigned to the speaker unit 401. For example, the signal processing unit 403 synthesizes a plurality of input signals with a plurality of filter coefficients to generate a multi-channel signal, and transmits the multi-channel signal to respective speakers of the speaker unit 401.

Depending upon the filter coefficient that the signal processing unit 403 selects from the filter storing unit 402, numbers, sizes, and locating positions of the control regions 101 and/or the sound zones 101 may be adjusted.

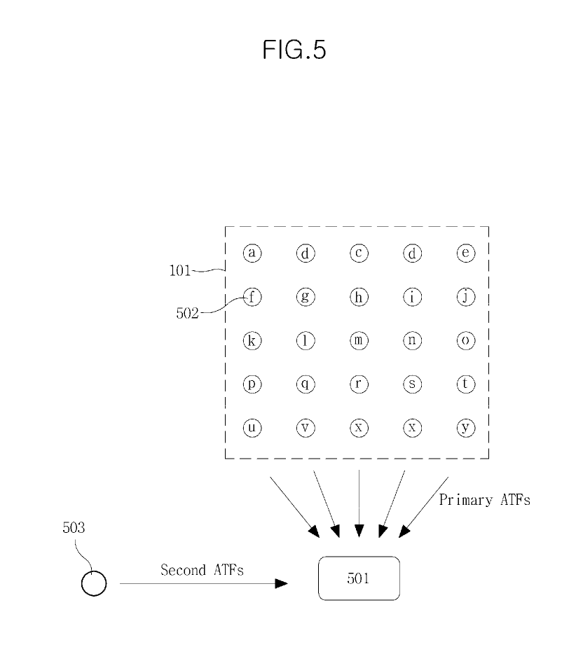

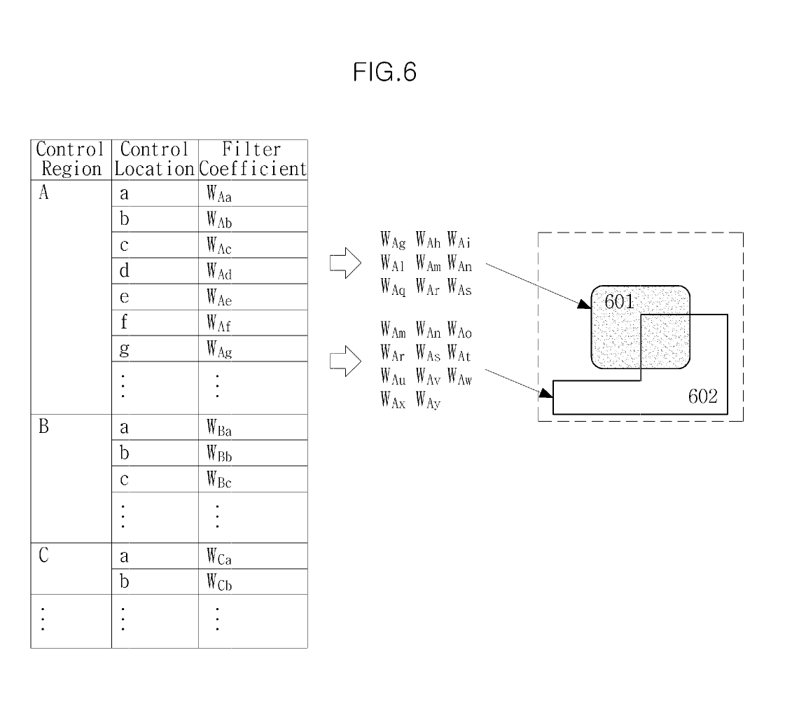

Examples of the relation between the setting of the control region 101 and the filter coefficients are described below with reference to FIGS. 5 and 6. FIGS. 5 and 6 are diagrams illustrating exemplary filter coefficients.

In FIG. 5, reference numeral ‘501’ indicates a user at an arbitrary location. Reference numeral ‘502’ may denote an arbitrary point in the control region 101 or a virtual sound source placed at the point. For convenience of explanation, the reference numeral ‘502’ will be referred to as a control position. In addition, the reference numeral ‘503’ may be an actual sound source corresponding to the above virtual sound source, and there may be a plurality of virtual and/or actual sound sources.

There may be a plurality of control positions 502 in the control region 101, and the primary ATFs may be acoustic transfer functions measured between each control position 502 and the user 501. Additionally, the second ATF may be an acoustic transfer function measured between the actual sound source 503 and the user 501. If a plurality of sound sources are provided, acoustic transfer functions may be measured between each sound source and a user, and even if there are a plurality of users, acoustic transfer functions may be obtained in the same manner.

For example, the speaker unit 401 may be placed at each control position 502 and output a test signal to measure the primary ATF at each control position 502, and then the speaker unit 401 may be placed at a position 503 of the actual sound source and output the same test signal to measure the second ATF.

If a particular filter which minimizes a difference between the primary ATF and the second ATF is applied for transforming the above test signal, a sound wave generated at the position 503 of the actual sound source can form acoustic energy distribution (e.g. acoustic energy distribution illustrated in FIG. 2) of each of the predetermined control positions 502, and thereby the user 501 may hear the sound as if it originated at the predetermined control position 502, although the sound is actually being generated at the position 503.

Moreover, when the position of the user 501 is matched with one of the control positions 502 corresponding to a position 102 (where the acoustic energy reaches a maximum in the graph illustrated in FIG. 2), the sound may be transferred to only to the user at the particular position 102.

The filter coefficients may be determined according to a condition where a difference in amplitude between the primary ATF and the second ATF is at a minimum. Example procedures of calculating the filter coefficients are described herein.

FIG. 6 is a diagram illustrating an exemplary list of filter coefficients obtained from each control location further illustrates exemplary sound zones 601 and 602 formed according to the determined filter coefficients.

Each of the filter coefficients may be pre-stored in the filter storing unit 402, or may be updated in real time. For convenience of explanation, although each filter coefficient is represented by letters (e.g. W_{Aa}) in FIG. 6, it can be understood that such reference letters do not necessarily illustrate a particular single coefficient, but rather a set of filter coefficients. Furthermore, the filter sets may be variable according to the number of control regions 101 or the sound zones 102. The filter sets may also be variable according to the size or locating positions of each of the control regions 101 or the sound zones 102.

When a plurality of filter coefficients are pre-stored in the filter storing unit 402, the filter processing unit 403 may select some of the filter coefficients from the filter storing unit 402, and apply the selected filter coefficients to the input signal. The number of the control regions 101 or the sound zones 102, and/or the locating position and size of each of the control regions 101 or the sound zones 102 may be adjusted according to the selected filter coefficients.

For example, when filter coefficients corresponding to a control region A and corresponding to control positions [g, h, i, l, m, n, q, r, s] are selected, a sound zone as represented by 601 may be formed in the control region A. Moreover, when filter coefficients corresponding to control positions [m, n, o, r, s, t, u, v, w, x, y] are selected, a sound zone as represented by 602 may be formed. A number of sets of selected filter coefficients may be determined previously or in consideration of the location of a user.

The above description is an example of adjusting the numbers, sizes and locating position of the control regions 101 and/or the sound zones 102, and other methods can be employed. In determining each of the control positions 502, an interested area may have the control positions 502 located relatively more closely to one another, or a weight may be applied to the corresponding area to reduce the amount of calculation.

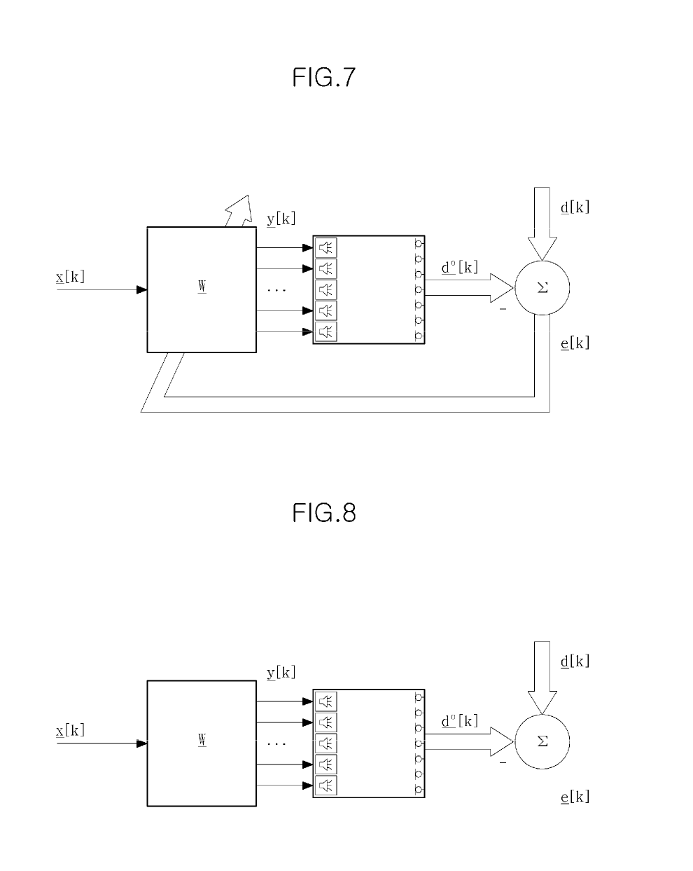

FIGS. 7 and 8 are diagrams illustrating examples for explaining the above filter coefficients.

FIG. 7 is a diagram illustrating an exemplary method of generating filter coefficients. The method employed in FIG. 7 may be applied to an example of an iterative manner of calculating the filter coefficients.

In FIG. 7, a difference between d(k) obtained by a primary ATF and d₀(k) obtained by a second ATFin relation with an input signal x(t) is defined as e(k), and the filter coefficient w which transforms the input signal x(t) for e(k) to become zero can be obtained.

The equations are as follows:

D₀(k)=W^{T}(ₖ)SA(k)x(k)

e(k)=d(k)−D₀(k)

W(k+1)=W(k)+μ(k)x(k)e(k). Equations 1

In equatins 1, d(k) may be object acoustic energy distribution, and d₀(k) may be real acoustic energy distribution based on a filter and acoustic transfer function. In equations 1, SA(k) is a second ATF matrix, and W(k) indicates a filter. In addition, μ(k) indicates an update step-size. That is, to produce filter coefficients, W(k) is calculated iteratively until e(k) becomes zero.

FIG. 8 is another diagram illustrating an exemplary method of generating filter coefficients. The method employed in FIG. 8 may be applied to an example of generating filter coefficients by matrix inversion.

Referring to FIG. 8, e(k) is defined as a difference between object acoustic energy distribution d(k) obtained by a primary ATF and real acoustic energy distribution d₀(k) obtained by a second ATF, and the filter coefficients that transform an input signal for e(k) to become zero can be obtained by following equations.

$$\begin{matrix}{d}_{0} ( k ) = {W}^{T} ( k ) SA ( k ) x ( k ) \\ e ( k ) = d ( k ) - {d}_{0} ( k ) \\ E [ {e}^{2} ( k ) ] = E [ {( d ( k ) - {W}^{T} ( k ) SA ( k ) x ( k ) )}^{2} ] \\ = \underline{{W}^{T}} E [ x ( k ) {x}^{T} ( k ) ] \underline{W} & Equations 2 \\ {[ \frac{\partial E [ {e}^{2} ( k ) ]}{\partial W ( k )} ]}_{min} = - 2 [ {R}_{fd} ( k ) - {\sum }_{i = 0}^{I} {h}_{i} {R}_{ff} ( k - i ) ] . & \end{matrix}$$

Here, R_{fd}(k) is cross-correlation between a target signal and an input signal, and R_{ff}(k) is auto-correlation between input signals, each of which can be specified as follows:

R_{fd}(k)=E[x(k)d(k+m)]

R_{ff}(k)=E[x(k)x(k+m)] Equations 3

Here, m denotes a signal sample length. Equations 3 can be rewritten as following matrix equations:

R_{fd}=R_{ff}W

W=R_{ff}⁻R_{fd}. Equations 4

Therefore, the filter coefficient can be obtained by measuring d₀(k) only once according to equations 4, and does not require iteration. Furthermore, in equations 4, when inversion of a matrix inversion R_{ff}⁻¹ is restricted by singularity, a solution of the matrix inversion for the filter coefficient can be obtained by the following equation:

W=R_{ff}⁺R_{fd}, R_{ff}⁺=[R_{ff}^{T}R_{ff}]⁻¹R_{ff}^{T}. Equation 5

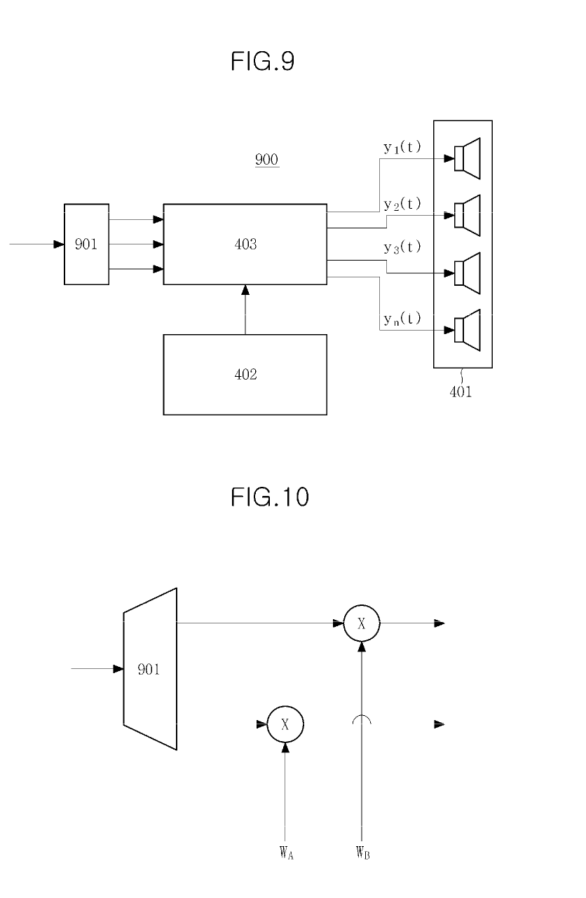

FIGS. 9 and 10 are diagrams illustrating an exemplary sound processing apparatus.

Referring to FIG. 9, the sound processing apparatus 900 may further include a channel splitting unit 901 in addition to the above configuration described with reference to FIG. 4.

The channel splitting unit 901 may be a decoder or a demultiplexer that splits a plurality of channels of an input signal into individual channels. For example, if the input signal is a TV broadcasting signal, the channel splitting unit 901 may split the TV broadcasting signal into a sports broadcasting signal and a drama broadcasting signal. As another example, if an input signal includes an English sound signal and a Korean sound signal (e.g. in multi-sound broadcasting), each of the English sound signal and the Korean sound signal can be split from the input signal.

The split input signals are synthesized with different filter coefficients as shown in FIG. 10 to form different control regions or different sound zones.

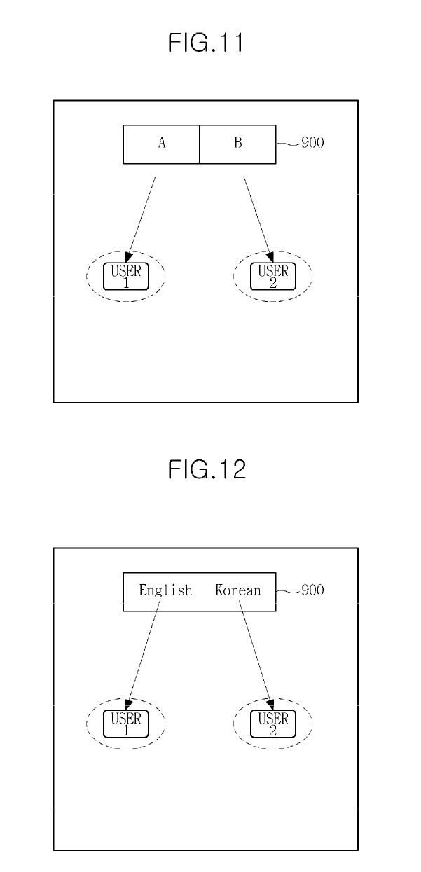

Application examples of the sound processing apparatus of FIGS. 9 and 10 will be described in detail with reference to FIGS. 11 and 12.

FIG. 11 is a diagram illustrating an exemplary situation where two broadcasting programs are displayed in a TV screen and individual users are selectively watching either of two broadcasting programs.

In FIG. 11, the sound processing apparatus 900 may include a TV which displays two broadcasting programs A and B on a single TV screen. In this case, the channel splitting unit 901 may split an input signal into an A broadcasting signal and a B broadcasting signal. Each of the split broadcasting signals may be synthesized according to different filter coefficients.

For example, if a first user 1 and a second user 2 watch different broadcasting programs (i.e. broadcasting A and broadcasting B) at the same time, a control region and a sound zone in relation to the A broadcasting signal are formed at the first user 1, and a control region and a sound zone in relation to the B broadcasting signal are formed at the second user 2. As a result, the first user 1 can only hear the sound from the A broadcasting without headphones.

FIG. 12 is another diagram illustrating an exemplary application of a sound processing apparatus 900. In FIG. 12, a television displays one broadcasting program and provides simultaneous two-language sound signals (e.g. multi-sound broadcasting).

In FIG. 12, the sound processing apparatus 900 may include a TV currently broadcasting a movie, which can output English sound and Korean sound at the same time. Similar to FIG. 11, the sound processing apparatus 900 splits the input signal into an English sound signal and a Korean sound signal, and individual split input signals are synthesized according to different filter coefficients. Accordingly, a control region and a sound zone in relation to the Korean sound are formed at the first user 2, and the control region and the sound zone in relation to the English sound are formed at the second user 1. Thus, each user can hear desired sound signal without disturbance in the same space.

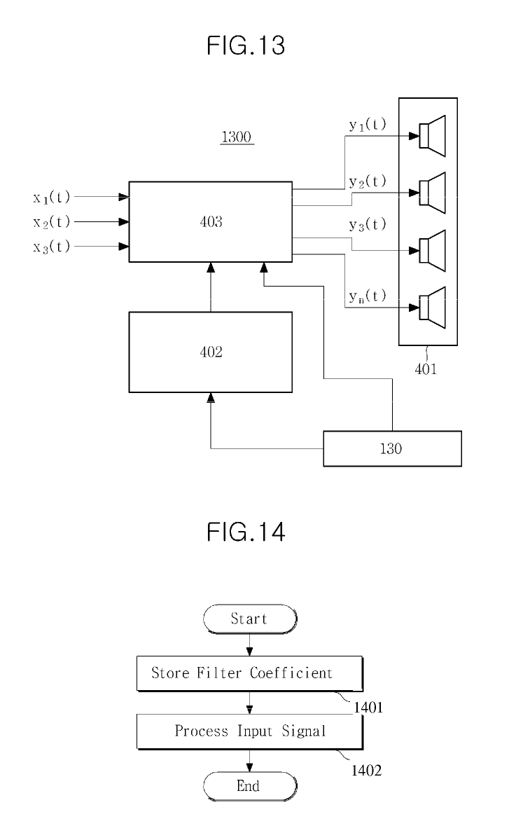

FIG. 13 is a diagram illustrating an exemplary sound processing apparatus 1300. Referring to FIG. 13, the sound processing apparatus 1300 may further include a sensor unit 130 in addition to the configuration described above with respect to FIG. 4.

The sensor unit 130 detects a location of a user and transmits location information to the filter storing unit 402 (refer to FIG. 4). The filter storing unit 402 may automatically select and extract filter coefficients, which are used to form a control region and a sound zone at the user, according to the location information of the user transmitted from the sensor unit 130.

Alternatively, when the input signal is formed of a plurality of channel signals, sound zones for individual channel signals may be formed at different locations. For example, the sensor unit 130 may detect the location of the user, a sound zone may be generated in front of the user in relation to bass signals, and individual sound zones are, respectively, formed at a left rear side and a right rear side of the user in relation to left channel signals and right channel signals.

FIG. 14 is a flowchart illustrating an exemplary sound processing method. Referring to FIG. 14, the sound processing method includes operations of providing filter coefficients (operation 1401), and synthesizing an input signal with the filter coefficients (operation 1402).

In operation 1402, the filter coefficients are determined for transformation of an input signal such that a sound zone is formed within a control region. A specific filter coefficient may be selected and extracted from the obtained filter coefficients.

The acquisition of the filter coefficients may be conducted with reference to FIG. 5 and equations 1 to 5.

For example, a first sound characteristic is measured based on a primary acoustic transfer function defined between a user and a virtual sound source located at an arbitrary position in a control region, and a second sound characteristic is measured based on a second acoustic transfer function defined between the user and an actual sound source. An error function indicating a difference between the first sound characteristic and the second sound characteristic is generated, and a filter coefficient is obtained by minimization of the difference according to the error function.

Moreover, selecting and extracting of filter coefficients for form a control region and a sound zone in a desired area may be performed by a sensor unit (i.e. 130 in FIG. 13) which detects a user or a location of the user.

In synthesizing the input signal with the filter coefficient, a multi-channel signal may be generated through the convolution between the input signal and the filter coefficient. When the input signal is formed of a plurality of channels, individual channel signals are synthesized with different filter coefficients such that sound zones for respective channel signals are formed at different regions.

As apparent from the above description, the number of sound zones, and/or the size and locating position of each sound zone can be adjusted by combining filter coefficients obtained at individual control positions, and thus acoustic energy distribution can be controlled in a desired area.

The methods described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. The computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A sound processing apparatus for processing an input signal, comprising:
a filter storing unit for storing filter coefficients for manipulating the input signal; and
a signal processing unit for processing the input signal according to at least one of the filter coefficients,
wherein a sound zone is formed in a control region according to the at least one of the filter coefficients.

2. The sound processing apparatus of claim 1, wherein the numbers, sizes, and locating positions of the control region and/or the sound zone are controlled according to the at least one of the filter coefficients.

3. The sound processing apparatus of claim 1, wherein the filter coefficients are determined according to a condition where a difference between a first sound characteristic obtained by a primary acoustic transfer function and a second sound characteristic obtained by a second acoustic transfer function is below a predetermined value.

4. The sound processing apparatus of claim 3, wherein the primary acoustic transfer function is an acoustic transfer function measured between a user and a virtual sound source located at an arbitrary position within the control region and the second acoustic transfer function is an acoustic transfer function measured between the user and an actual sound source.

5. The sound processing apparatus of claim 1, wherein the sound zone has acoustic energy that is different than acoustic energy of a remaining area of the control region.

6. The sound processing apparatus of claim 1, further comprising a channel splitting unit for splitting the input signal into individual channel signals, wherein the input signal comprises a plurality of channel signals.

7. The sound processing apparatus of claim 6, wherein the filter storing unit applies a different filter coefficient to each of the plurality of individual channel signals split by the channel splitting unit.

8. The sound processing apparatus of claim 1, further comprising a sensor unit to detect a user's location.

9. The sound processing apparatus of claim 8, wherein the control region and the sound zone are determined according to the user's location.

10. A sound processing method of processing an input signal, comprising:
storing filter coefficients for manipulating the input signal; and
processing the input signal according to at least one of the filter coefficients,
wherein a sound zone is formed in a control region according to the at least one of the filter coefficients.

11. The sound processing method of claim 10, wherein the storing of the filter coefficients comprises:
measuring a first sound characteristic obtained by a primary acoustic transfer function between a user and a virtual sound source located at an arbitrary position within the control region;
measuring a second sound characteristic obtained by a second acoustic transfer function between the user and an actual sound source; and
generating the filter coefficients for transforming the sound source such that a difference between the first sound characteristic and the second sound characteristic is below a predetermined value.

12. The sound processing method of claim 11, wherein the filter coefficient is determined in an iterative manner.

13. The sound processing method of claim 11, wherein the filter coefficient is determined by matrix inversion.

14. The sound processing method of claim 10, wherein the filter coefficients comprise a plurality of sets of filter coefficients, and numbers, sizes, and locating positions of the control region and/or the sound zone are adjusted according to a combination of the plurality of sets of the filter coefficient.

15. The sound processing method of claim 10, wherein when the input signal includes a plurality of channel signals, the processing of the input signal comprises applying a different filter coefficient to each of the plurality of individual channel signals.
